(19) United States
(12) Patent Application Publication
(10) Pub. No.: US 2012/0058279 A1
(43) Pub. Date: Mar. 8, 2012

(54) METHOD AND APPRATUS FOR COATING WORKPIECES

(76) Inventor: Johannes Schmid, Starzach-Wachendorf (DE)

(21) Appl. No.: 13/132,183

(22) PCT Filed: Nov. 30, 2009
(86) PCT No.: PCT/EP09/66035

§ 371 Date: Jul. 14, 2011

(30) Foreign Application Priority Data
Dec. 1, 2008 (DE) 20 2008 015 878.8
Feb. 24, 2009 (EP) 09002588.3

(51) Int. Cl. B05D 7/06; B05D 5/00; B05D 3/06; B05C 13/00; B05D 3/12; B05C 9/12; B05C 11/00; B05D 7/14; B05D 3/10

(52) U.S. Cl. 427/536; 427/369; 427/554; 427/553; 427/547; 427/560; 427/337; 118/620; 118/58

(57) ABSTRACT

The invention relates to a method for coating workpieces (2), which consist at least partly of wood, wood materials or the like, comprising the following steps: providing a workplace (2), which consists at least partly of wood, wood materials or the like, supplying a coating material (12) which is to be applied to a surface (2a) of the workpiece (2), applying energy to a surface (2a) of the workplace in such a way that lignin contained in the material of the workpiece (2) involves adhesive properties, at least at the surface (2a) of the workpiece that is to be coated, and pressing the coating material (2) against a surface (2a) of the workpiece, wherein the coating material (12) is at least partially bonded to the workplace (2) by using the adhesive properties of the lignin.

### TECHNICAL FIELD

The invention relates to a method and an apparatus for coating workpieces which preferably consist at least partly of wood, wood materials, plastic or the like.

### PRIOR ART

Apparatuses for coating workpieces of the type specified at the start have been known for a long time, for example in the form of edge banding machines in the field of the furniture and components industry. Thus, for example, DE 34 47 592 discloses an edge banding apparatus wherein the edge material is supplied by a supply device and a hot melt adhesive is applied here to the surface of the edge material facing towards the workpiece. Next the edge material is pressed by means of a pressure roller onto the surface of the workpiece to be coated.

Although this technology has proved to be of value over a long period of time, the ever more stringent requirements in the furniture and components industry give rise to the desire for improved solutions for the coating of workpieces. Essential aspects here are firstly the every increasing diversity of coating materials which come in a wide range of thicknesses and materials and require individual solutions. Moreover, however, more and more frequently a so-called “piece number—1” production is required wherein for every workpiece a different coating material is to be provided. This requires a high degree of variability and adaptability of the coating apparatus.

Moreover, the handling and application of hot melt adhesive to the coating material can lead to contamination and interruptions in the operating procedure, and this can have a negative impact upon the reliability of the processing.

Last but not least, the requirements for the operational speed and capacity of the coating apparatuses are also constantly increasing, and so there is also a requirement for an accelerated mode of function of the coating apparatus.

### DESCRIPTION OF THE INVENTION

It is therefore the object of the invention to provide a coating method and a coating apparatus of the type specified at the start which enable reliable, flexible and at the same time efficient operation.

This object is achieved according to the invention by a method for coating workpieces according to Claim 1 and an apparatus for coating workpieces according to Claim 5. Particularly preferred further developments of the invention are specified in the dependent claims.

The idea forming the basis of the method according to the invention is to make direct use of the material properties of the wood materials or wood-based materials often used for the workpieces for adhering a coating material. Against this background the method according to the invention is characterized in that energy is applied to a surface of the workpiece in such a way that lignin contained in the material of the workpiece displays adhesive properties, at least at the surface of the workpiece that is to be coated. The coating material is pressed onto a surface of the workpiece, the coating material being at least partially bonded to the workpiece by using the adhesive properties of the lignin.

By means of this totally new type of procedural method the use of an adhesive agent or an agent that can be made adhesive to be supplied can be reduced. Depending on the application one can even totally dispense with the use of an adhesive agent or an agent that can be made adhesive to be supplied. In this way the coating procedure can be made reliable, flexible and at the same time efficient.

By applying energy to the lignin contained in the workpiece to be coated, the latter is melted or fused so that the lignin displays adhesive properties. Within the framework of the following invention these properties are advantageously used in order to apply the coating material to the respective workpiece. Here, within the framework of the present invention, the energy can be applied directly or indirectly to the surface of the workpiece. Indirect application of the energy can take place, for example, by reflection or also by other appropriate mechanisms. It is therefore possible, for example, to use the coating material itself as a transmitting medium for reflected radiation, heat or other appropriate forms of energy. In this way it becomes possible, for example, to enable at the same time an application of energy both into the coating material and into the surface of the workpiece so that one can optionally work with a single, or in any case, a reduced number of energy sources.

As already mentioned, within the framework of the present invention it is possible to produce the connection between the coating material and the respective workpiece exclusively by means of the lignin contained in the workpiece. However, according to a further development of the invention provision is made such that an additional adhesive agent or agent that can be made adhesive is applied to the surface of the workpiece and/or the coating material. In this way a particularly reliable and high-quality connection can be achieved, the use of the lignin in many cases leading to a greatly reduced quantity of adhesive agent or agent that can be made adhesive to be supplied.

For the activation or the fusing of the lignin a wide variety of energy sources are suitable; these will be discussed in greater detail below.

Furthermore, the invention provides an apparatus for coating workpieces according to Claim 5. The idea forming the basis of the apparatus according to the invention is to work on the interface between the coating material and the workpiece, and to replace the previously used pre-heated hot-melt adhesive with new types of connection technology. For this purpose provision is made according to the invention such that the apparatus for coating workpieces has at least one energy source for applying energy to an adhesive agent or an agent that can be made adhesive, that can be provided independently and/or can be part of the coating material and/or of the workpiece. In this way clearly far-reaching possibilities are created for matching the connection procedure of the coating material onto the workpiece to the respective requirements, and so enable optimal operation of the coating apparatus for each individual case. In this way, even with the so-called “piece number—1” production an optimal combination of precise, flexible and efficient operation is offered.

Within the framework of the present invention the energy source can be configured differently, the term “energy” within the framework of the present invention being to be considered in a broad sense. According to the invention provision is made here such that the at least one energy source is chosen from the group consisting of laser, infrared source, ultrasound source, magnetic field source, microwave source, plasma source and gassing source. This list makes it clear that in addition to classic energy sources, energy sources which apply energy to the coating material, for example by means of a chemical reaction, for example a gassing source, can also be considered. Within this context it should also be noted that the respective energy source can on the one hand activate an agent already available as an adhesive agent, and on the other hand can also make an agent not serving as an adhesive agent into an adhesive agent by exposing to energy, a chemical reaction or the like. Furthermore, it should be noted that within the framework of the invention in principle any energy source can be used.

Each one of the aforementioned energy sources has its specific advantages. Thus, a laser makes it possible to work in a particularly targeted and efficient way, whereas infrared and plasma sources allow broad operation and a good depth effect. Energy sources with ultrasound, magnetic field and microwave work contact-free and can also introduce further energy into the process when pressing on the coating material. A magnetic field in particular has a good depth effect here. An energy source based on gassing is particularly suitable, by its effect upon and reaction with the coating material, even for forming a first material which has adhesive properties.

Within the framework of the present invention the coating material is preferably provided in the form of a stock in the supply device, within the framework of the present invention the coating material being chosen from a wide variety of materials. According to a further development of the invention it is preferred here if the material of the coating material is chosen from the group consisting of plastic, veneer, paper, cardboard, metal and combinations of the latter.

According to a further development of the invention provision is further made such that the coating material 12 has at least partly an integral or discrete layer which displays adhesive properties when energy is supplied. In this way it is no longer absolutely necessary within the framework of the invention to provide a conventional adhesive agent application, but rather this function can be integrated into the edge supply. Total integration of the adhesive agent or agent that can be made adhesive into the coating material thus enables very simple and efficient operation of the apparatus according to the invention. In contrast, the design of the adhesive agent or agent that can be made adhesive as a discrete layer which is connected at an appropriate time to the coating material has the advantage of a greater diversity of variants, and so with the latterly mentioned configuration, even for the widest range of coating material types, only a single discrete layer of an adhesive agent or agent that can be made adhesive needs to be provided.

Alternatively or in addition, it can, however, also be advantageous within the framework of the present invention if the apparatus further comprises at least one adhesive agent providing device which is set up to apply an already adhesive agent or an agent which is still to be made adhesive by exposing the coating material and/or workpiece to energy. In this way the diversity of variants of the apparatus is further increased, and one can also work with combinations of different adhesive agents so that by means of the apparatus according to the invention practically any coating material can be applied to practically any workpiece. It is particularly preferred here if the apparatus has at least two adhesive agent providing devices which provide adhesive agents or agents which can be made adhesive which are different from one another.

According to a further development of the invention provision is further made such that the pressing device is set up to apply the coating material onto a narrow surface and/or a wide surface of the workpiece. With the apparatus according to the invention workpieces of any form can thus be produced furthermore with precise, flexible and efficient operation.

In particular when applying coating material to a wide surface of the workpiece it is advantageous according to a further development of the invention if the at least one energy source is arranged moveably, preferably transversely to the direction of a relative movement generated by the conveyer device between the pressing device and the respective workpiece. In this way large-scale coating materials can also be applied efficiently with a single or a small number of energy sources.

Within the framework of the present invention the conveyer device can be configured in a wide variety of ways, for example such that the respective workpiece is provided stationarily, and one or more components of the apparatus are moveable in relation to the workpiece. These types of stationary machine are characterized by a very small space requirement and very great variability. According to a further development of the invention provision is made, however, such that the conveyor device is set up to convey the workpieces in a throughput direction, the conveyor operation possibly being continuous, or optionally also cyclical. In this way particularly efficient and disruption-free operation of the apparatus according to the invention with a high throughput is achieved.

The individual structural units of the apparatus according to the invention can in principle be arranged as independent, fixed or moveably fitted units. According to a further development of the invention provision is made, however, such that at least the pressing device and the energy source are combined to form one unit which can be exchanged via an interface into a supply unit, such as for example into the tool holder of a spindle unit. In this way an apparatus which is variable and flexible to a high degree can be created with which a wide variety of workpieces and feed materials can be processed without providing an excessively large number of components. In particular due to the exchangeability of the unit comprising the pressing device and the energy source the number of drive units required is reduced because different units can be driven and supplied by the common supply unit (for example a spindle unit).

Furthermore, provision is made according to a further development of the invention such that the apparatus has a focussing device which is set up to direct the energy provided by the energy source onto selected areas of the adhesive agent to be activated or to be produced. In this way a number of effects can be achieved at the same time. On the one hand the operation of the apparatus can be matched without any problem to different dimensions of the coating material without conversion work having to be carried out on the respective energy source. Therefore the effective surface can be set with different dimensions punctiformly or linearly, but also two-dimensionally.

Moreover, by means of the focussing device the intensity of the energy applied to the adhesive agent can, however, also optionally be varied so that an optimal coating result can be achieved without any damage to the coating material.

In connection with this it is particularly preferred if the energy source and/or the focussing device is/are set up to oscillate. In this way local energy peaks can be avoided, and uniform covering of the area to be exposed to energy can be brought about. It is particularly preferred here if the energy source and/or the focussing device is/are set up to oscillate faster the faster the relative movement is in relation to the workpiece.

The focussing device can in principle direct the energy provided by the energy source onto any point of the coating material or optionally also of the workpiece or adhesive agent. According to a further development of the invention provision is, however, made here such that the focussing device is set up to direct the energy provided by the energy source in the area directly upstream of a pressing area in which the coating material is pressed onto a surface of a workpiece. In this way one can work with a minimal quantity of energy, and not only does this reduce energy consumption, but also minimizes possible negative impacts upon the materials exposed to energy.

According to a further development of the invention the apparatus further comprises a control device which is set up to match the operation, in particular the output of the energy source, to the properties and dimensions of the adhesive agent or agent that can be made adhesive and to the relative speed between the energy source and the adhesive agent. In this way an optimal coating result can be achieved under all operating conditions and for all materials used, even under commercial working conditions in which one can work with an optimal application of energy with an optimal quantity of adhesive agent, etc.

### BRIEF DESCRIPTION OF THE DRAWINGS

FIG. 1 shows diagrammatically a top view of a coating apparatus 1 as a preferred embodiment of the present invention;

FIG. 2 shows diagrammatically a top view of a coating apparatus 1 as a second preferred embodiment of the present invention;

FIG. 3 shows diagrammatically a top view of a coating apparatus 1 as a third preferred embodiment of the present invention;

FIG. 4 shows diagrammatically a side view of a coating unit for a coating apparatus according to the invention.

### DETAILED DESCRIPTION OF PREFERRED EMBODIMENTS

Preferred embodiments of the present invention are described in detail below with reference to the accompanying drawings.

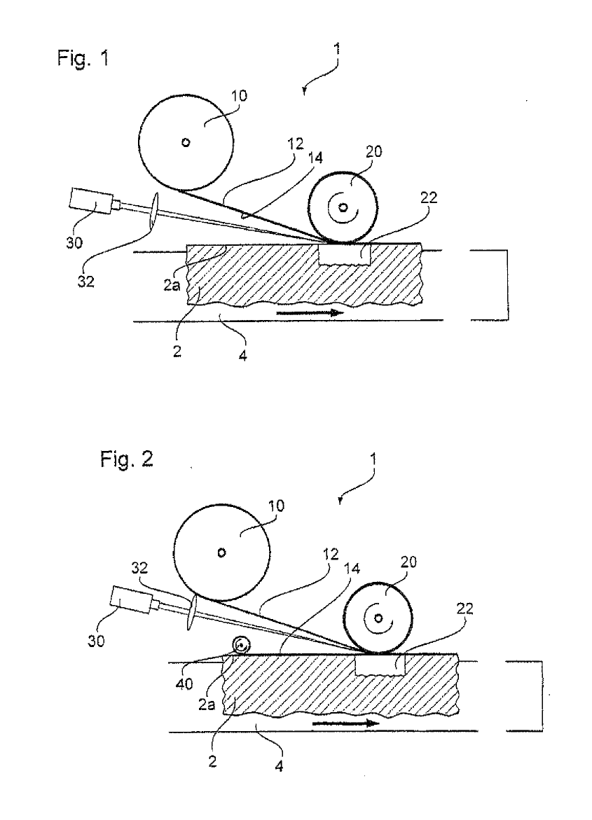

A coating apparatus 1 for coating workpieces 2 as a preferred embodiment of the present invention is shown diagrammatically in a top view in FIG. 1. In the present embodiment the coating apparatus 1 serves to coat board-shaped workpieces 2 which are made at least partly of wood, wood materials, plastic or the like, such as are used nowadays, for example, in the field of the furniture and components industry. These can be a wide variety of workpieces, such as for example solid wood or chip-boards, lightweight building boards, sandwich boards, skirting boards, profiles for profile casing etc. It should be noted, however, that the present invention is not restricted to these types of workpiece.

The coating apparatus 1 initially comprises a conveyor device 4 which in the present embodiment is in the form of a throughput conveyor device, for example in the faun of a roller conveyor, a belt conveyor or the like. Here the conveyor device 4 serves to convey the workpieces 2 in a throughput direction (from left to right in FIG. 1).

There is arranged next to the conveyor device 4 a supply device 10 for supplying a coating material 12, the coating material being, for example, an edge material for a narrow surface of the workpiece, but also possibly a covering material for a wide surface or any other surface of the workpiece 2. The supply device 10 contains a stock of coating material 12 which can consist of a wide variety of materials, such as for example plastic, veneer, paper, cardboard, metal, etc., and numerous combinations of the latter. The coating material can be provided, for example, in roll form (optionally within a cassette) here, but also in the form of individual sections.

In the present embodiment according to FIG. 1 this is, however, a coating material which contains an integral or discrete layer 14 which displays adhesive properties when energy is supplied, this type of integral coating material possibly being formed, for example, by a plastic material which contains a layer 14 which displays adhesive properties when energy is supplied. By providing a discrete layer 14 the rest of the coating material can in principle be made of any material. In any case the discrete layer 14 is disposed on the side of the coating material 12 facing towards the workpiece 2.

The supply device 10 guides the coating material 12 to a pressing device 20 for pressing the coating material 12 onto a surface 2a of the workpiece 2. In the present embodiment the pressing device 20 is a pressure roller (instead of a pressure roller belts, shoes or the like, for example, can also be used) which rolls over the surface 2a of the workpiece 2 and in this way presses the coating material 12 onto the surface 2a of the workpiece 2.

The coating apparatus 1 further comprises an energy source 30 for applying energy to the adhesive agent or agent that can be made adhesive 14. Within the framework of the present invention a wide variety of energy sources can be considered here, such as for example laser, infrared source, ultrasound source, magnetic field source, microwave source, plasma source, gassing source, etc. All of these energy sources 30 provide energy in directed form and direct the latter onto the adhesive agent or the agent that can be made adhesive 14 which is supplied as an integral or discrete part of the coating material 12.

This bundled or directed energy is shown in FIG. 1 by a line passing from the energy source 30. This passes through a focussing device 32 which is set up to direct the energy provided by the energy source 30 towards selected areas of the adhesive agent 14 to be activated or to be implemented. It should be noted, however, that within the framework of the invention the energy source 30 can also be positioned at some other appropriate place. Thus, according to a general further development of the invention an energy source can, for example, also be integrated into the pressing device and/or the conveyor device.

In the simplest case the focussing device 32 can be a lens. It should be noted, however, that depending on the energy source 30 different focussing devices 32 can be used, it being possible to set up the focussing device respectively in order to set the spread and optionally also the intensity of the applied energy. In this way the focussing device 32 directs the energy provided by the energy source 30 into the area directly upstream of a pressing area 32 in which the coating material 12 is pressed onto the surface 2a of the workpiece 2.

This operation of the energy source 30 and also of the focussing device 32 is controlled by a control device (not detailed), the control device matching in particular the output of the energy source 30 to the properties and dimensions of the adhesive agent or the agent that can be made adhesive 14 as well as to the relative speed between the energy source 30 and the adhesive agent 14. In addition the control device can also evaluate information from sensors which monitor the operation of the coating apparatus, for example sensors which are arranged in the area of the pressing area 22 and for example record the temperature of the coating material 12 applied. Upon the basis of this information the control device can control not only the energy source 30, but optionally also the focussing device 32.

It should be noted here that in the present embodiment the focussing device 32 is set up to oscillate if so required, for example in a direction perpendicular to the plane of the drawing in FIG. 1. An oscillation movement here is to be understood as a vibration with a frequency of for example at least 10 Hz (e.g. 50 Hz). Here the control device ensures that the faster the relative movement is in relation to the workpiece 2, the faster the focussing device oscillates.

Furthermore, in the present embodiment the focussing device 32 can move together with the energy source 30 in a direction transverse to the throughput direction of the conveyor device 4. This is particularly advantageous for large-scale coating tasks, such as for example for coating the wide surfaces of workpieces.

In addition or alternatively to activation of an adhesive agent or an agent that can be made adhesive 14 (which can be supplied in any form), the apparatus 1 according to the invention also, however, makes the method according to the invention possible wherein lignin contained in the respective workpiece 2 is used to apply the coating material 12 to the surface 2a of the workpiece 2. For this purpose no basic modifications to the apparatus 1 are required. However, the energy source 30 for this, for example with the aid of the focussing device 32, is set up and adjusted such that lignin contained in the material of the workpiece 2 displays adhesive properties, at least on the surface 2a of the workpiece to be coated. Admittedly it is a pre-requisite for this that lignin is contained in the workpiece to be coated, i.e. that the workpiece is made at least partly of wood, wood materials or the like.

Next, or simultaneously to activating the lignin, the coating material 12 is pressed onto the surface 2a of the workpiece so that the coating material is connected to the workpiece by utilizing the adhesive properties of the lignin. In this respect, with regard to the procedure, there are no fundamental differences in comparison to the method described above which is based exclusively upon a supplied adhesive agent or agent that can be made adhesive 14. Furthermore, as already mentioned, the adhesive effect of the lignin can be combined with the adhesive effect of a separately supplied agent 14.

In order to activate or fuse the lignin the energy of the energy source 30 can be applied directly to the surface 2a to be coated. Alternatively or in addition it is also possible to apply the energy for example to the coating material 12. This energy can, for example, be reflected by the coating material 12 or be introduced in the form of residual heat into the surface 2a of the workpiece.

This procedural method, wherein the adhesive effect of the lignin is specifically activated and used, can be varied in many different ways, and in particular also be used individually or in combination with a separately supplied adhesive agent or agent that can be made adhesive 14 in the embodiments described below. Furthermore, it should be noted that lignin contained in the coating material can also be correspondingly activated and used to combine the coating material with the workpiece.

A second preferred embodiment of the coating apparatus 1 according to the invention is shown diagrammatically in a top view in FIG. 2. This primarily differs from the first embodiment shown in FIG. 1 in that the adhesive agent or the agent that can be made adhesive 14 is not supplied together with the coating material 12, but is applied to the surface 2a of the workpiece 2 to be coated by means of an adhesive agent providing device in the form of an adhesive agent applicator roll 40. Alternatively or in addition it is of course also possible to apply the adhesive agent to the coating material 12 by means of the adhesive agent providing device 40.

The adhesive agent or agent that can be made adhesive 14 thus applied is then also activated or produced by exposing to energy by means of the energy source 30, and once again directly upstream of a pressing area 22.

Although not shown in FIG. 2, the coating apparatus 12 according to the invention can also needless to say also have further adhesive agent providing devices such as, for example, a second adhesive agent applicator roll or the like, these different adhesive agent providing devices preferably also providing adhesive agents or agents that can be made adhesive 14 that are different from one another. In this way on the one hand particular effects can be achieved on a single workpiece, and on the other hand it is also possible to use the different adhesive agent providing devices alternately as required with different workpieces and basic conditions.

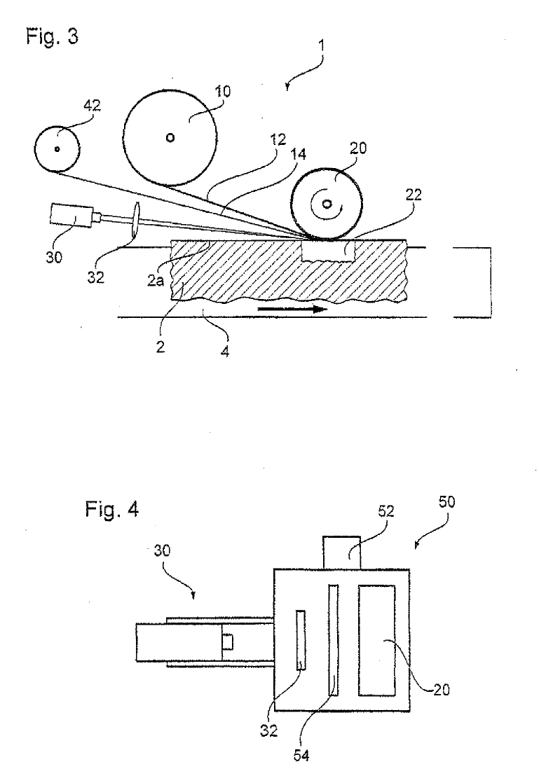

A third preferred embodiment of the coating apparatus 1 according to the invention is shown diagrammatically in a top view FIG. 3. The latter is characterized in that the adhesive agent or agent that can be made adhesive 14 is provided in the form of a sheet material from an adhesive providing device 42. This sheet material 14 is supplied synchronously with the coating material 12 in an area between the coating material 12 and the workpiece 2 and then exposed to energy in the area directly upstream of a pressing area 22 and made adhesive. In this way a change in coating material 12 can take place at any time without any problem, while one can constantly work with the same adhesive agent or agent that can be made adhesive.

A preferred configuration of the pressing device 20 and the energy source 30 is shown diagrammatically in a side view in FIG. 4. In this embodiment the pressing device 20 and the energy source 30 are combined to form a unit 50 which can be exchanged via an interface 52 into a supply unit, such as for example into the tool holder of a spindle unit. The interface 52 can for example be a universal interface as disclosed in the Applicant's Patent Application EP 0 743 139.

The exchangeable unit 50 can also carry the focussing device 32 and moreover have a supply slot 54 for the coating material so that the latter can be supplied without any problem to the pressure roll 20 and be exposed to energy 30 by means of the energy source 30 from the opposite side. However, it should be noted that in this embodiment too—as generally within the framework of the invention—alternative or additional exposure to energy of the workpiece can also take place.

This type of unit is particularly well suited to stationary machines, but also to pass-through machines, and enables particularly variable and flexible operation of these types of machine, it being possible to correspondingly reduce the number of supply units (spindle units) required.

1. A method for coating workpieces which consist at least partly of wood, wood materials or the like, comprising the steps:
providing a workpiece which consists at least partly of wood, wood materials or the like,
supplying a coating material which is to be applied to a surface of the workpiece,
applying energy to a surface of the workpiece in such a way that lignin contained in the material of the workpiece displays adhesive properties, at least on the surface of the workpiece that is to be coated, and
pressing the coating material against a surface of the workpiece, wherein the coating material is at least partially bonded to the workpiece by using the adhesive properties of the lignin.

2. The method according to claim 1, characterized in that the energy is applied directly or indirectly to the surface of the workpiece.

3. The method according to claim 1 or 2, characterized in that an additional adhesive agent or agent that can be made adhesive is applied to the surface of the workpiece and/or the coating material.

4. The method according to claim 1 or 2, characterized in that the energy is applied by means of an energy source that is chosen from the group consisting of laser, infrared source, ultrasound source, magnetic field source, microwave source, plasma source and gassing source.

5. An apparatus for coating workpieces which preferably consist at least partly of wood, wood materials, plastic, aluminum or the like, comprising:
a supply device for supplying a coating material,
a pressing device for pressing the coating material onto a surface of a workpiece,
a conveyor device for bringing about a relative movement between the pressing device and the respective workpiece, and
at least one energy source for applying energy to an adhesive agent or agent that can be made adhesive that can be provided independently and/or can be part of the coating material and/or of the workpiece, characterized in that
the at least one energy source is chosen from the group consisting of laser, infrared source, ultrasound source, magnetic field source, microwave source, plasma source and gassing source.

6. The apparatus according to claim 5, characterized in that the supply device contains a stock of coating material the material of which is chosen from the group consisting of plastic, veneer, paper, cardboard, metal and combinations of the latter.

7. The apparatus according to either of claims 5 and 6, characterized in that the coating material has at least partly an integral or discrete layer which displays adhesive properties when energy is supplied.

8. The apparatus according to any of claims 5 and 6, characterized in that it further comprises at least one adhesive agent providing device which is set up to apply an agent that is already adhesive or can be made adhesive by exposing to energy to the coating material and/or workpiece.

9. The apparatus according to claim 8, characterized in that it has at least two adhesive agent providing devices which provide adhesive agents or agents that can be made adhesive that are different from one another.

10. The apparatus according to any of claims 5 and 6, characterized in that the pressing device is set up to apply the coating material to a narrow surface and/or a wide surface of the workpiece.

11. The apparatus according to any of claims 5 and 6, characterized in that the at least one energy source is arranged moveably, and preferably transversely to the direction of a relative movement between the pressing device and the respective workpiece generated by the conveyor device.

12. The apparatus according to any of claims 5 and 6, characterized in that the conveyor device is set up to convey the workpieces in a throughput direction.

13. The apparatus according to any of claims 5 and 6, characterized in that it further comprises a focussing focusing device which is set up to direct energy provided by the energy source towards selected areas of the adhesive agent to be activated or produced.

14. The apparatus according to any of claims 5 and 6, characterized in that the energy source and/or the focussing focusing device are set up to oscillate.

15. The apparatus according to claim 14, characterized in that the energy source and/or the focussing focusing are set up to oscillate faster the faster the relative movement is in relation to the workpiece.
